(19) United States
(12) Patent Application Publication
(10) Pub. No.: US 2008/0085690 A1
(43) Pub. Date: Apr. 10, 2008

(54) Method and apparatus of passive scanning

(76) Inventor: Ilya Shnayderman, Jerusalem (IL)

Correspondence Address: PEARL COHEN ZEDEK LATZER, LLP, 1500 BROADWAY, 12TH FLOOR, NEW YORK, NY, 10036, US

(21) Appl. No.: 11/543,100

(22) Filed: Oct. 5, 2006

(51) Int. Cl. H04B 1/18

(52) U.S. Cl. 455/187.1

(57) ABSTRACT

A wireless communication system that include an association that include an access point and two or more stations. A station in unassociated mode that seeks to join the association performs a periodically passive scanning in a predetermined point of time for a predetermined period of time. The predetermined point of time is determined by a global clock.

### BACKGROUND OF THE INVENTION

Wireless local area networks (WLAN) may include a basic service set (BSS). The BSS may include an access point (AP) and one or more stations (STA). A BSS may also be referred as association. A wireless medium between the AP and the stations includes plurality of channels. The stations may include mobile and/or fixed station. The mobile stations may scan the channels in order to join the BSS.

There are at least two types of scanning, a passive scanning and an active scanning. In the passive scanning the mobile station sweeps from channel to channel and record information from any beacons it receives. The mobile station monitors each channel for a predetermined time period, for example 300 ms. In other passive scanning method the AP may send Gratuitous Probe Responses (GPR) and the mobile station records the AP information from GPRs. The GPR is sent as an Information Element in a beacon, and as a separate frame sent by the AP at regular intervals between beacons Beacon spacing may be 100 ms, and GPR spacing may be 10 ms

In active scanning the mobile station may sweep from channel to channel and send a probe request and the AP may response with a probe response. In both types of scanning, especially in the passive scanning, the mobile station may spend a long period of time for scanning.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to some exemplary embodiments of the present invention;

FIG. 2 is a block diagram of a station according to some exemplary embodiments of the present invention;

FIG. 3 is a block diagram of an access point according to exemplary embodiments of the present invention; and

FIG. 4 is a flow chart of a method of passive scanning in a wireless local area network (WLAN) according to exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

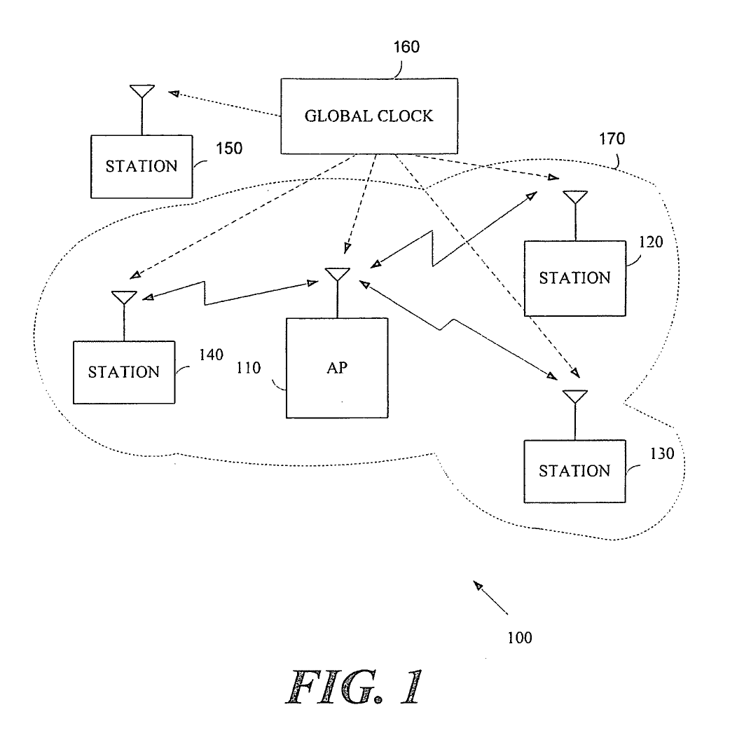

Turning firstly to FIG. 1, a wireless communication system 100, for example, a WLAN is shown. Although the scope of the present invention is not limited in this respect, the exemplary WLAN 100 may be defined, by IEEE 802.11-1999 standard, as a BSS. For example, the BSS may include at least one communication station, for example, an AP 110, and stations 120, 130 and 140. Stations 120, 130, 140 and AP 110 may form an association 170. Station 150, for example a wireless Internet Protocol (IP) phone, may operate in an unassociated mode and may perform a passive scanning in order to join association 170.

According to exemplary embodiments of the invention, a global clock 160 may send a global time to AP 110 and stations 120, 130, 140 and 150. The stations may synchronize their scanning interval with AP 110, according to global clock 160. Although the scope of the invention is not limited in this respect, global clock 160 may be provided by a Global Positioning System (GPS) and/or Metropolitan wireless local aria network and/or a cellular system and/or the like.

According to some exemplary embodiments of the invention, AP 110 may have an internal clock. The internal clock of AP 110 may be synchronized with internal clock of stations 120, 130, 140 and 150 according to the global time which may be provided by global clock 160. AP 110 may send, at a predefined point of time of its internal clock, a beacon and/or GPR on at least one operation channel of the wireless medium. The frequency of beacons and/or the at least one operation channel may be configured by AP 110. A station, for example station 150 may perform a passive scanning in order to join association 170.

According to one exemplary embodiment of the invention, station 150 may include a list of channels that station 150 may scan, if desired. Station 150 may include a clock that may be synchronized with the global time provided by the global clock 160 (e.g., GPS). Station 150 may periodically select a channel to listen on for a predetermined period of time. During the passive scanning, station 150 may recognize an AP message (for example, GPR message) sent over the network. Station 150 may send a probe request in order to join association 170, if desired.

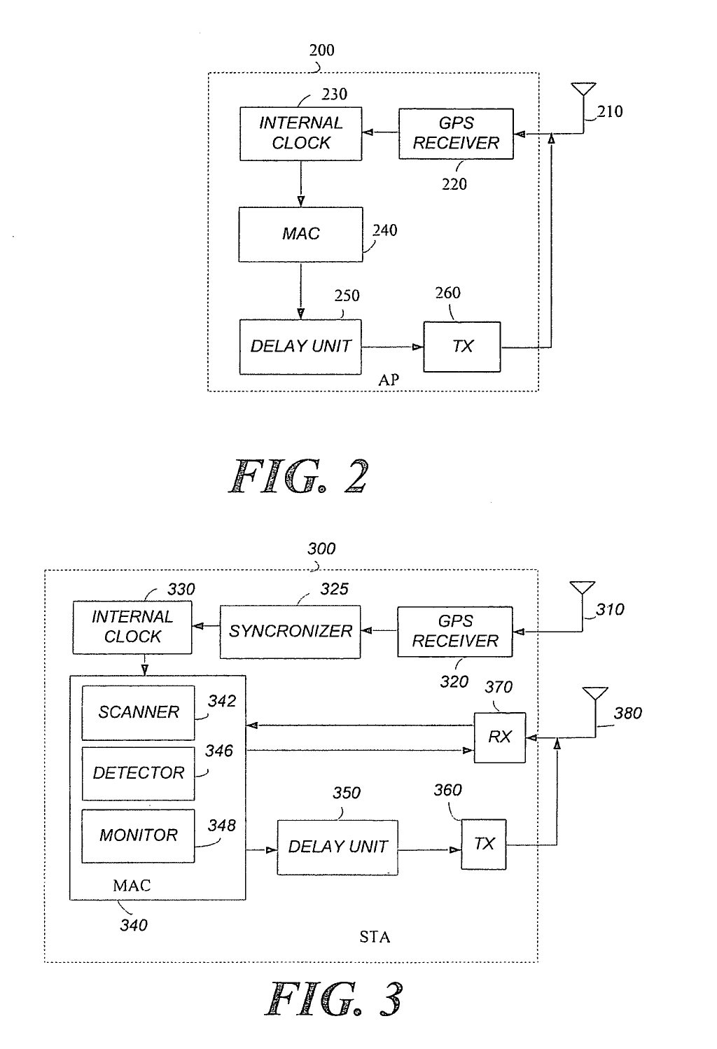

Turning to FIG. 2, a block diagram of an access point (AP) 200 according to exemplary embodiments of the present invention is shown Although the scope of the present invention is not limited in this respect, station 200 may include an antenna 210, a GPS receiver 220, an internal clock 230, a medium access control (MAC) processor 240, a delay unit 250 and a transmitter (TX) 260.

According to some exemplary embodiments of the invention, GPS receiver 220 may receive from antenna 210 a global time, if desire. Internal clock 230 may synchronize with the global time. AP 200 may periodically transmit GPR and/or beacons according to pluses of internal clock 230. According to one exemplary embodiment of the invention, internal clock 230 may send pulses to interrupt MAC processor 240. MAC processor 240 may generate the GPR and/or beacons, delay unit 250 may delay the transmission of the GPR and/or beacons according to a desired medium access scheme and TX 260 may transmit the GPR and/or beacons via antenna 210.

Although the scope of the present invention is not limited in this respect, antenna 210 may be an omni-directional antenna, a monopole antenna, a dipole antenna, an end fed antenna, a circularly polarized antenna, a micro-strip antenna, a diversity antenna, a GPS antenna or the like. MAC processor 240 may include a digital signal processor, a communication processor, or the like.

Turning to FIG. 3 a block diagram of a station 300 according to some exemplary embodiments of the present invention is shown. Although the scope of the present invention is not limited in this respect, station 300 may include a GPS antenna 310, a GPS receiver 320, a synchronizer 325, an internal clock 330, a medium access control (MAC) processor 340, a delay unit 350 and a transmitter (TX) 360, a receiver (RX) 370 and an antenna 380. According to some exemplary embodiments of the invention, MAC processor 340 may include a scanner 342, a detector 346 and a monitor 348

According to some exemplary embodiments of the invention, GPS receiver 320 may receive from GPS antenna 310 a global time, if desire. Synchronizer 325 may synchronize internal clock 330 with the global time. Furthermore, synchronizer 325 may set the predetermined point of time for performing passive scanning according to the global clock. Station 300 may be in unassociated mode and may seek to join the association which includes an AP and one or more other stations.

According to embodiment of the invention, scanner 342 may perform a passive scanning at a predetermined point of time for example, a global point of time. Scanner 342 may scan one or more channel of the WLAN medium. For example, scanner 342 may periodically wake up receiver 370. Monitor 348 may monitor the at least one selected channel for a predetermined time period to detect a signal (e.g., receiving GPR and/or beacons. which may be received from AP). The periodically wake ups for monitoring the GPR and/or beacons may be done according to pluses of internal clock 230.

According to one exemplary embodiment of the invention, the clocks of the AP and station 300 may be synchronized with the global time. Thus, the wake up time and the monitoring time period are synchronized with the transmissions of GPR and/or beacons. Although the scope of the present invention is not limited in this respect, the monitoring time period may be greater then the GPR and/or beacon transmission time. For example, the GPR time may be 1.5 mSec and the monitoring time period may be 2 mSec, if desired.

In some embodiments of the invention the wake up time may precede the GPR and/or beacon transmissions, if desired. For example, internal clock 330 may periodically send pulses to interrupt MAC processor 340. MAC processor 340 may select a channel to listen on and may send a request to receiver 370 to wake up and monitor the selected channel for a predetermined period of time. Detector 346 may detect a signal transmitted at the predetermined point of time by the AP. For example, detector 346 may detect a GPR and/or beacon messages. In response to the detecting the message, MAC processor 340 may generate a probe response in order to join to the association, if desired. According to this exemplary embodiment of the present invention, delay unit 350 may delay the probe response message in order to avoid collisions and transmitter 360 may transmit the probe response via antenna 380, if desired.

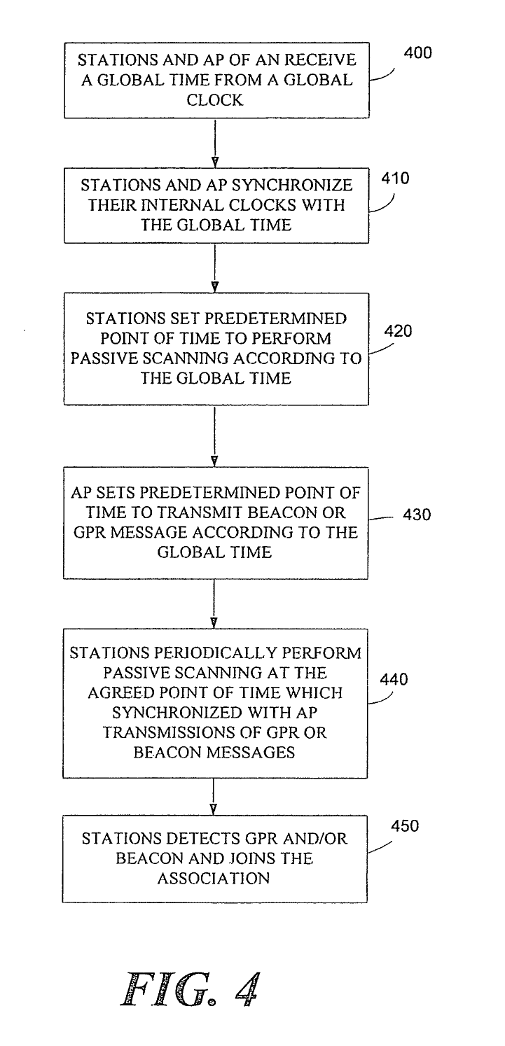

Turning to FIG. 4 a method of passive scanning in a wireless local area network (WLAN) according to exemplary embodiments of the present invention is shown Although the scope of the present invention is not limited in this respect, an AP and stations of the WLAN may receive a global time from a global clock for example, GPS (text block 400). According to one exemplary embodiment of the invention, the stations and the AP may synchronized their internal clock with the global time (text block 410), if desired. The AP and the stations of the WLAN may set a predetermined point of time to perform the passive scanning according to the global time (text blocks 420, 430). For example, at the predetermined point of time the stations may wake up and monitor a selected channel for receiving transmissions of beacon and/or GPR and the AP may transmit beacon and/or GPR

According to embodiments of the present invention, a station in an unassociated which seeks to join an association of the AP and a one or more stations may perform a periodic passive scanning at the predetermined points of time. The predetermined points of time may be synchronized with the AP transmissions of GPR and/or beacon (text block 440). If the station detect a GPR and/or beacon that related to the association the station may join the association (text block 450)

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
performing a passive scanning at a predetermined point of time in an unassociated mode to detect a signal transmitted at the predetermined point of time by an access point.

2. The method of claim 1 comprising:
setting the predetermined point of time according to a global clock

3. The method of claim 1, comprising:
monitoring a channel at the predetermined point of time for a predetermined time period.

4. The method of claim 1, wherein detecting the signal comprises detecting a beacon message.

5. The method of claim 1, wherein detecting the signal comprises detecting a gratuitous probe response message.

6. A wireless communication device comprising:
a scanner to performing a passive scanning at a predetermined point of time in an unassociated mode; and
a detector to detect a signal transmitted at the predetermined point of time by an access point.

7. The wireless communication device of claim 6, comprising:
a receiver to receive a desired time according to a global clock; and
a synchronizer to set the predetermined point of time according to the global clock

8. The wireless communication device of claim 6, comprising:
a monitor to monitor a channel at the predetermined point of time for a predetermined time period to detect the signal.

9. The wireless communication device of claim 6, wherein the signal comprises a beacon.

10. The wireless communication device of claim 6, wherein the signal comprises a gratuitous probe response.

11. A wireless communication device comprising:
a dipole antenna to receive a signal from a channel of a wireless medium;
a scanner to performing a passive scanning at a predetermined point of time in an unassociated mode; and
a detector to detect the signal at the predetermined point of time by an access point.

12. The wireless communication device of claim 11 comprising:
a receiver to receive a desired time according to a global clock; and
a synchronizer to set the predetermined point of time according to the global clock.

13. The wireless communication device of claim 11, comprising:
a monitor to monitor a channel at the predetermined point of time for a predetermined time period to detect the signal.

14. The wireless communication device of claim 11, wherein the signal comprises a beacon.

15. The wireless communication device of claim 11, wherein the signal comprises a gratuitous probe response.

16. A wireless communication system comprising:
at least one wireless communication device that includes a scanner to performing a passive scanning at a predetermined point of time in an unassociated mode and a detector to detect a signal transmitted at the predetermined point of time by an access point.

17. The wireless communication system of claim 16, wherein the at least one wireless communication device comprises:
a receiver to receive a desired time according to a global clock; and
a synchronizer to set the predetermined point of time according to the global clock

18. The wireless communication system of claim 16, wherein the at least one wireless communication device comprises:
a monitor to monitor a channel at the predetermined point of time for a predetermined time period to detect the signal.

19. The wireless communication system of claim 16, wherein the signal comprises a beacon.

20. The wireless communication system of claim 16, wherein the signal comprises a gratuitous probe response.

21. A processor comprising: a storage medium, having stored thereon instructions, that when executed, result in:
performing a passive scanning at a predetermined point of time in an unassociated mode to detect a signal transmitted at the predetermined point of time by an access point.

22. The processor of claim 21 wherein the instructions, that when executed, result in:
setting the predetermined point of time according to a global clock

23. The processor of claim 21 wherein the instructions, that when executed, result in:
monitoring a channel at the predetermined point of time for a predetermined time period.

24. The processor of claim 21 wherein the instruction of detecting the signal, when executed, results in detecting a beacon message.

25. The processor of claim 21 wherein the instruction of detecting the signal, when executed, results in detecting a gratuitous probe response message.
